(19) United States
(12) Patent Application Publication
(10) Pub. No.: US 2016/0112300 A1
(43) Pub. Date: Apr. 21, 2016

(54) METHOD AND DEVICE FOR SELECTING A COMMUNICATION INTERFACE

(71) Applicant: COMMISSARIAT A L'ENERGIE ATOMIQUE ET AUX ENERGIES ALTERNATIVES, Paris (FR)

(72) Inventors: Arnaud KAISER, Gif-sur-Yvette (FR); Alexandru PETRESCU, Gif-sur-Yvette (FR); Christophe JANNETEAU, Gif-sur-Yvette (FR)

(21) Appl. No.: 14/890,101

(22) PCT Filed: May 6, 2014
(86) PCT No.: PCT/EP2014/059183

§ 371 Date: Nov. 9, 2015

(30) Foreign Application Priority Data
May 13, 2013 (FR) 1354267

(51) Int. Cl. H04L 12/721; H04L 12/26; H04L 29/12

(52) U.S. Cl. CPC H04L 45/123; H04L 61/6059; H04L 43/0876

(57) ABSTRACT

A method and a device for selecting a communication interface of a source host so as to transmit data to a destination host in an optimal manner. The method allows the source host to calculate the total route cost to the destination host from each of its interfaces, as a function of the routing metrics, and to select the interface corresponding to the lowest value of total route cost.

### FIELD OF THE INVENTION

The invention relates to the field of network communications and in particular concerns a method and a device for selecting a communication interface for the routing of data.

### PRIOR ART

With the ever more advanced developments in electronics and in information and communication technologies, the commercialization of communicating kit equipped with several different communication interfaces is commonplace. For example, a laptop computer can be connected to the Internet by a wired connection, of Ethernet type, and by a wireless connection (Wifi) simultaneously. A cellular telephone is connected to the Internet both by its Wifi antenna and by its 3G antenna. When the user of such an item of equipment wishes to send data, an interface of the equipment is selected for sending. The choice may be made for example on the first interface of the list of the interfaces which exist on the equipment. The interface adopted depends on the policy set in place by the operating system installed on the equipment. However, the interface selected may lead to poor utilization of the resources of the network, resulting in a degradation of the quality of the network, such as reduced bandwidth, transmission lags, data losses.

Moreover, non-optimal routing of data may involve retransmission of the data and then bring about an increase in the energy consumption of the network equipment.

Solutions exist for allowing a more optimal selection of an interface on a multi-interface host. Thus, patent application WO 2010/097057 of Sarikaya et al. proposes a scheme for configuring a multi-interface host and selecting an interface based on routing information contained in a Dynamic Host Configuration Protocol (DHCP) message. However, such an approach is limited to a local overview of the host, and the interface selected is that which proposes the most advantageous metric of the immediate link.

In international patent application WO 2012/087184 of Telefonaktiebolaget LM Ericsson entitled “Energy Efficient Routing and Switching”, a scheme for carrying out routing based on an energy consumption metric is presented. A router (first node 211) endowed with several interfaces is used to dispatch routing messages which contain the network view such as perceived by this node, and to listen to the messages of the other nodes. After having received all the messages, the first node calculates the best paths, based on energy consumption, and stores them in a routing table. This scheme operates according to routing protocols such as the Open Shortest Path First (OSPF) or the IS-IS (Intermediate System to Intermediate System). The drawback of a scheme is that its application is limited to the core network, dynamic routing protocols such as OSPF not being applicable at the edge of a network, that is to say to equipment carried by a user, such as a smartphone or a tablet, or to “end system” computers.

Known solutions also exhibit a drawback related to the security of the routing of the data in the network. Indeed, the exchanges of the routing protocols are performed only between routers of the network which are under the strict control of the network operator. The routing messages generally being authenticated to avoid any compromise of the routing tables of the routers, any host node cannot participate directly in the routing protocol while taking the risk of compromising the security of the routing in the operator's network.

Moreover, a local network such as a domestic network or a company network is generally more restricted in terms of network resources than a core network such as that of an Internet Service Provider (ISP), and the optimization of the routing of the data within a local network such as this is therefore more critical.

Thus, the known approaches do not meet all the data routing optimization needs. The proposed invention makes it possible to meet these needs.

### SUMMARY OF THE INVENTION

An object of the present invention is to propose a method of interface selection which allows an item of multi-interface user equipment to select the most appropriate sending interface for optimizing the routing of data within a local network.

Another object of the present invention is to propose a method which combines a protocol suitable for end equipment, such as the Neighbor Discovery protocol, with a network core protocol, such as the OSPF protocol, while using the same cost metric.

Advantageously, the metric can characterize the energy of the communication links, that is to say the quantity of energy corresponding to the sending of a data packet over the link, but can also rely on any type of metrics associated with the links of the network such as quality of service metrics (bandwidth, latency, packet loss rate) or security metrics (level of security on the link).

Advantageously the present invention avoids the porting of an expensive, in terms of calculation and storage resources, routing protocol onto an end terminal (or “end system”).

Advantageously, the invention does not present any security risk as regards a compromise of the routing tables since its method does not require that the multi-interface host node participate explicitly in the routing protocol.

Advantageously, the present invention will be implemented in contexts where multi-interface terminals have to dispatch data within a network. In particular, it will find advantage in the following sectors:
domestic networks;
company networks;
cellular systems grouping together diverse radio access technologies;
multi-hop ad hoc networks, mainly wireless, and in particular those grouping together various types of radio or wired links;
vehicular networks.

In the context of ad hoc networks, the present invention allows multi-interface terminals to communicate effectively within the ad hoc network, that is to say to benefit from optimal routing of the traffic without having to execute the ad hoc routing protocol locally, such as the OLSR (Optimized Link State Routing) protocol for example.

In the context of vehicular networks, the present invention can apply to tablets, as well as to multi-interface mobile routers. A multi-interface mobile router is understood to be a communication gateway onboard a vehicle and interconnecting one or more networks internal to the vehicle to the external infrastructure via diverse network interfaces.

To obtain the results sought, a method, a device and a computer program product are proposed.

In particular, the invention applies in a communication network consisting of a plurality of routers connected by communication links and comprising at least one source host equipped with several communication interfaces for sending and receiving data, each interface being connected to a router of the communication network via a communication link having a link cost. The claimed method for selecting an interface of the source host to transmit data to a destination host connected to the communication network, comprises the steps of:

sending from each interface of the source host a solicitation message (RS) to the router to which said interface is connected, to request the route cost to the destination host;

receiving on the corresponding interface of the source host an advertisement message (RA) of the router to which said interface is connected giving a value of the route cost from said router to the destination host;

calculating on the basis of the values received and of the link cost value of the corresponding link, the value of the total route cost to the destination host from the source host for each interface;

comparing the total route cost values obtained; and

selecting the interface corresponding to the lowest value of total route cost.

In a variant, the step of route cost advertisement message (RA) reception comprises a step of verifying whether the advertisement message (RA) received contains a route cost option, or ignoring the message.

In another variant, an initial step makes it possible to determine the link cost of each link between each interface of the source host and the router to which said interface is connected and to select the interface having the lowest link cost as default interface.

In a preferential manner, an identifier of the selected interface is stored in a routing table of the source host.

In an implementation variant, the step of selecting a default interface consists in receiving on each interface of the source host an advertisement message (RA) of the router to which said interface is connected which comprises a link cost value calculated according to a link cost calculation metric defined for said communication network. Advantageously, the protocol of said communication network is the IPv6 protocol, and the step of selecting a default interface is done according to a neighbor discovery protocol (ND).

In another implementation variant, the link cost is calculated for various routing metrics and the solicitation message (RS) contains an indication of the metric or metrics for which to calculate the link cost.

The invention relates moreover to a system for selecting a communication interface, the system comprising means for implementing all the steps of the claimed method.

The invention can operate in the form of a computer program product which comprises code instructions making it possible to perform the steps of the claimed method when the program is executed on a computer.

### DESCRIPTION OF THE FIGURES

Various aspects and advantages of the invention will become apparent in support of the description of a preferred but nonlimiting mode of implementation of the invention, with reference to the figures hereinbelow:

FIG. 1 schematically shows a source host connected to several routers via various links in a communication network;

FIGS. 2a and 2b show the procedures executed by the routers and the source host of FIG. 1 for the selection of a default interface;

FIG. 3 schematically shows an example of various routes between a source host and a recipient host;

FIG. 4 shows the exchanges of messages occurring for the selection of a route in the example of FIG. 3;

FIG. 5 shows the procedures executed by a router in the example of FIG. 3;

FIG. 6 shows the procedures executed by the source host in the example of FIG. 3.

### DETAILED DESCRIPTION OF THE INVENTION

To allow proper understanding of the description, a terminology of the main terms used is given hereinafter:

1 IPv6 Address: Unique identifier of a node in the network. The IPv6 address is composed of two parts: a prefix as left part and an interface identifier as right part.
Cost of the link: Metric associated with the link.
Dynamic Host Configuration Protocol for IPv6 (DHCPv6): Dynamic configuration protocol for the hosts of a network. It makes it possible notably to allot a complete IPv6 address to a host.
Host: Terminal equipment of a user which possesses at least one communication interface for sending/receiving data and which does not allow the routing of data.
Interface Identifier: Right part of the IPv6 address of a node which makes it possible to identify it on a link. The Interface Identifier must be unique among all the Interface Identifiers on one and the same link.
Link: Direct physical connection between two nodes. The connection can be wired (Ethernet cable, optical fiber, etc.) or wireless (radio waves: wifi, bluetooth, 3G, etc.).
Metric: Non-zero positive value associated with a link. It makes it possible to describe the link and to compare it with the other links of the network. Examples of metrics of a link are: bitrate, loss rate, lag, security level, energy, etc. A particular example is the quantity of energy corresponding to the sending of an IP packet over this link. The metric is used by the routing protocols in the calculation of the best routes: the higher the metric of a link, the more the link in question will be avoided since, in general, a high metric implies a poor quality link.
Maximum Transmission Unit (MTU): Maximum size of the data included in an IPv6 packet. If the quantity of data to be transmitted is greater than the MTU, the data must be fragmented into several IPv6 packets.
Neighbor Discovery (ND): Routing protocol on the scale of the link (also called “one hop” routing) which allows the configuration of a host that connects up to the network.
Node: Any item of communicating IPv6 equipment (router or host) connected to the network.
Prefix: Left part of the IPv6 address of a node which makes it possible to identify a specific link in the network. The prefix is the part used by routers to route traffic to a destination. It must be unique within the network and is shared by the nodes connected to one and the same link.
Router Advertisement (RA): Signaling message of the ND protocol sent by a router either periodically and destined for all the nodes present on the link (multicast communication), or in response to an RS sent by a specific node (unicast communication).
Router: Item of communicating equipment endowed with at least two communication interfaces and whose role is to route the data packets from one node to another in the network.
Router Solicitation (RS): Signaling message of the ND protocol sent by a host and destined for one or for all the routers present on the link.
StateLess Address Auto Configuration (SLAAC): Mechanism allowing a host to generate locally, based on its MAC address, the Interface Identifier part of its IPv6 address. The configuration of a host by SLAAC is generally opposed to configuration by DHCPv6.

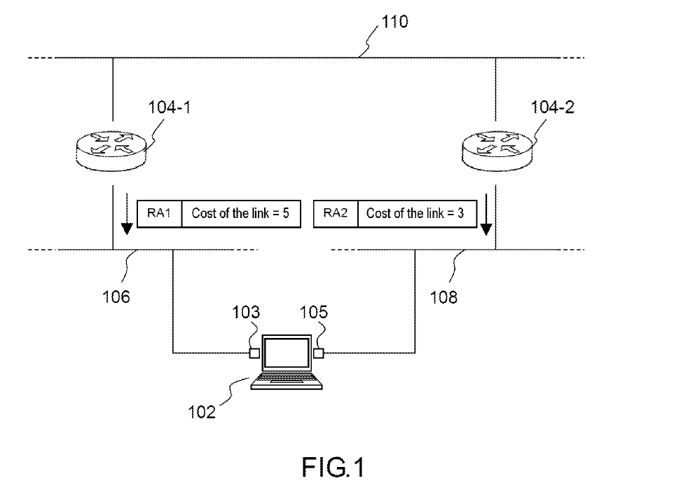

FIG. 1 illustrates an exemplary network communication infrastructure 100 in which to advantageously implement the invention. For reasons of simplicity of description and not of limitation of the invention, the example of FIG. 1 shows only a finite number of hosts and routers, but a person skilled in the art will extend the principles described to a plurality and a variety of hosts (102-i), of routers (104-i) and of number and type of connection links.

A host (102) is connected by a first interface I1 (103) to a first router (104-1) via a first link (106) and by a second interface I2 (105) to a second router (104-2) via a second link (108). Each router can itself be connected to other nodes of the network via various links (110).

In order to be connected to the network, the host (102) recovers from each router present on the link to which it is connected, the information necessary for its configuration, such as an IPv6 prefix, the selection of a default route, its auto-configuration by SLAAC or DHCPv6, or else the size of the MTU. Each router provides the host with the parameters necessary for its configuration. In IPv6 networks, the neighbor discovery (ND) protocol is in charge of this exchange of information through Router Solicitation (RS) messages, and Router Advertisement (RA) messages.

A person skilled in the art will be able to refer to the “Request for Comments” (RFC) 4861 for a more detailed description regarding the format and the content of the messages (RS) and (RA) according to the IPv6 protocol.

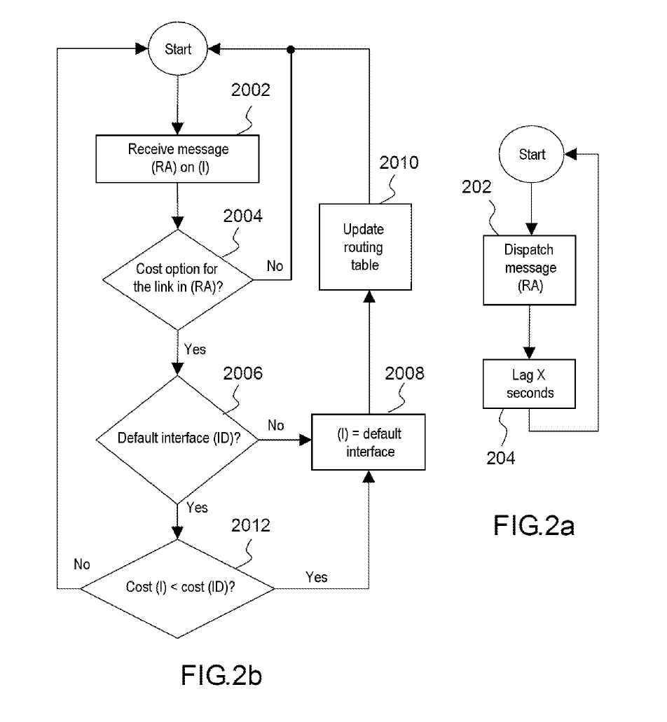

FIGS. 2a and 2b show the procedures executed by the routers (104-1, 104-2) and the source host (102) of FIG. 1 for the selection of a default interface on the source host.

A router sends (202) an advertisement message (RA) over its link to the source host. According to the principle of the invention, the message contains in a new option the cost of the link. In a preferential implementation, the cost of the link, or “Link Cost”, is included in a field of the new option of the message (RA) as an unsigned integer on 32 bits, such as shown schematically hereinafter for a message (RA) according to the IPv6 protocol:

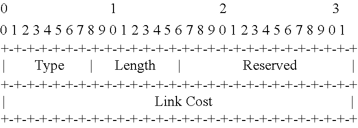

The meaning of the fields is as follows:

Type: Code identifying the option. Unsigned integer on 8 bits.

Length: Length of the option. Unsigned integer on 8 bits.

Reserved: Unused field, set to zero by the sender.

Link Cost: Cost of the link. Unsigned integer on 32 bits.

The advertisement message (RA) is dispatched periodically (204) on the link. According to RFC 4861 which defines the “ND” protocol, the period of dispatch of the RA messages is arbitrary but must be a minimum of 3 seconds. The value of this dispatch period which can be configured by a network administrator does not have any impact on the manner of operation of the present invention.

FIG. 2b shows the steps effected at the level of the host (102) so as to allow it to select its default interface in accordance with the routing metric used in the network. The host receives (2002) an advertisement message (RA) of a router on one of its interfaces (I). The method verifies (2004) whether the message received contains a link cost indication. If this option is not in the message received, the method waits for the reception of a new message (NO branch).

If the advertisement message (RA) received contains an item of information about the cost of the link (YES branch), the method continues to the following step (2006) where it verifies whether a default interface is assigned. If no interface is assigned, the method selects (2008) the current interface (I) as default interface (ID). This item of information is stored (2010) in the routing table of the host.

If a default interface (ID) is already assigned (YES branch), the method compares in a following step (2012) the cost of the link received on the current interface (I) with the cost of the link on the default interface (ID). If the cost of the link of the current interface is less than the cost of the link of the default interface (YES branch), the method selects (2008) the current interface as default interface (ID) and updates its routing table (2010) by storing an identifier of the selected interface.

If the cost of the link of the current interface is greater than or equal to the cost of the link of the default interface (NO branch), the method retains the default interface and waits for a next message (RA).

Thus, with each reception of a message (RA) containing the link cost option on an interface, the host assigns the cost of the link advertised in the message to this interface. It thereafter defines its default interface by selecting the one whose cost is the lowest. In the example of FIG. 1, the routers send periodic RA messages. The first router (104-1) sends over the first link (106) an advertisement message (RA1) which includes the link's cost option, with a link cost value of “5”. The second router (104-2) sends over the second link (108) an advertisement message (RA2) which includes the link's cost option, with a link cost value of “3”. These messages allow the host (102) to assign the link cost value “5” to its interface I1 (103) and the link cost value “3” to its interface I2 (105). The method implemented allows the interface I2 to be selected as default interface since it has the lowest link cost.

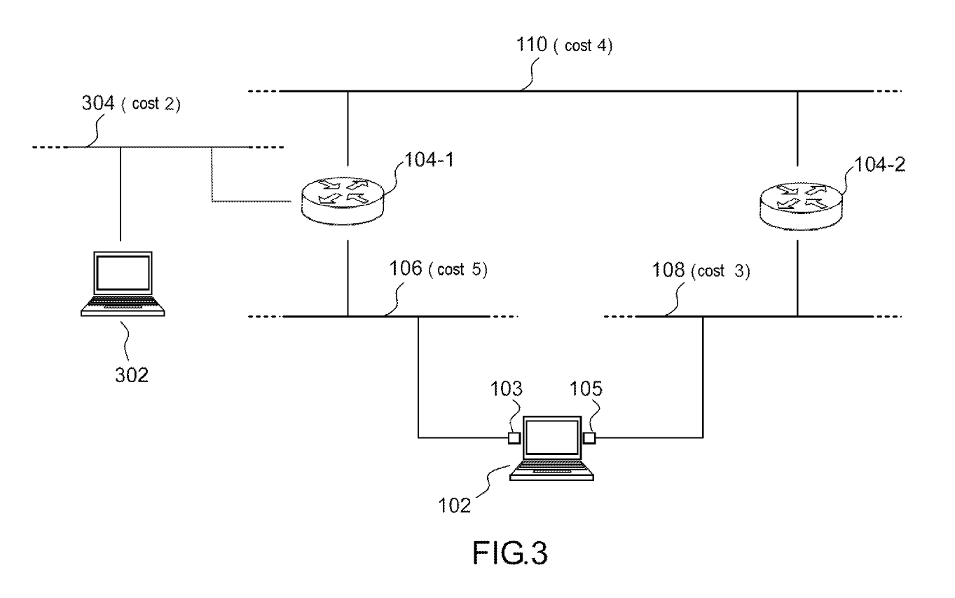

FIG. 3 schematically shows an example of various possible routes between a source host (102) and a recipient host (302). The recipient host (302) is connected to the first router (104-1) by a link (304) which has a link cost of value “2”. The elements in common with FIG. 1 retain the same references and are not described again. In the example of FIG. 3, a link (110) exists between the two routers (104-1, 104-2) which has a cost of value “4”. Although the source host has a default interface selected according to the network routing metric, the systematic use of the latter for all its communications may not be optimal on an end-to-end path followed by the data. Indeed, the host being connected to various links of the network by virtue of its various interfaces, the use of its default interface for certain communications may give rise to “detours” as a function of the location of the destination node in the network and therefore give rise to additional costs. In order that the source host be able to select an interface for optimal communication to a recipient host, the method of the invention makes it possible to give the source host a more global overview of the end-to-end path to the destination by allowing it to compare the cost of each possible route to the recipient host and to select the best route.

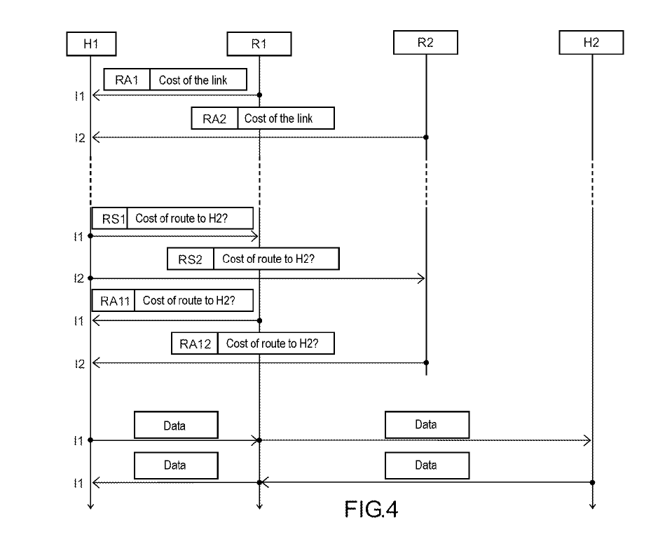

FIG. 4 shows the exchanges of messages occurring between the various entities of FIG. 3 for the selection of a route. In a preliminary step, the source host (H1) receives on each of its interfaces (I1, I2) advertisement messages (RA1, RA2) respectively of the connected routers (R1, R2) containing the corresponding values of link cost. The source host selects its default interface according to the method of FIG. 2b.

When the source host (H1) wishes to send data to a destination (H2), if no entry to this destination exists in its routing table, it sends a request (RS1, RS2) on each of its interfaces to ask the respective routers for the cost of the end-to-end path to the destination (H2).

The routers respond by each dispatching an advertisement message (RA11, RA12) advertising respectively the cost of the shortest path, to their knowledge, to reach said destination.

Moreover, the response messages to the route cost request contain in a preferential manner:

either the IPv6 address of the destination if the routing policy implemented is of routing type based on the address of the host or “host-based routing”;

or the prefix and its size corresponding to the destination address if the routing policy implemented is of conventional routing type based on the prefixes or “network-based routing.”

The cost advertisement messages contain in a preferential manner the route cost indication or “Path Cost”, according to the format schematically represented hereinafter:

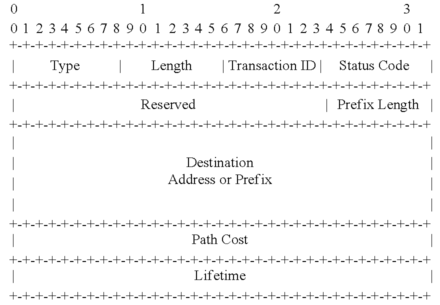

The meaning of the fields is as follows:
Type: Code identifying the option. Unsigned integer on 8 bits.
Length: Length of the option. Unsigned integer on 8 bits.
Transaction Number identifying the exchange of messages RS/RA
ID: between host and router. Unsigned integer on 8 bits. The option contained in an RA message dispatched in response to an RS message must contain the same transaction number as that contained in the option of the RS message.
Status Code: Code which gives information which is complementary to the response such as “destination address requested inaccessible”, “successful transaction”. Unsigned integer on 8 bits. Set to zero in an RS message.
Reserved: Unused field, set to zero by the sender and ignored by the receiver.
Prefix Length: Unsigned integer on 8 bits. In an RA message, contains the length of the prefix of the Destination Address/Prefix field. Set to zero in an RS message.
Destination In an RS message: IPv6 address of the destination for
Address which the cost of the path is requested. In a RA message:
or Prefix: IPv6 address of the destination or else prefix corresponding to this destination according to the routing policy implemented (“host-based routing” or “network-based routing”).
Path Cost: Cost of the end-to-end path from the router which sends the RA message up to the destination. Unsigned integer on 32 bits. Set to zero in an RS message.
Lifetime: Duration of validity in seconds of the item of information advertised in the RA. Set to zero in an RS message.

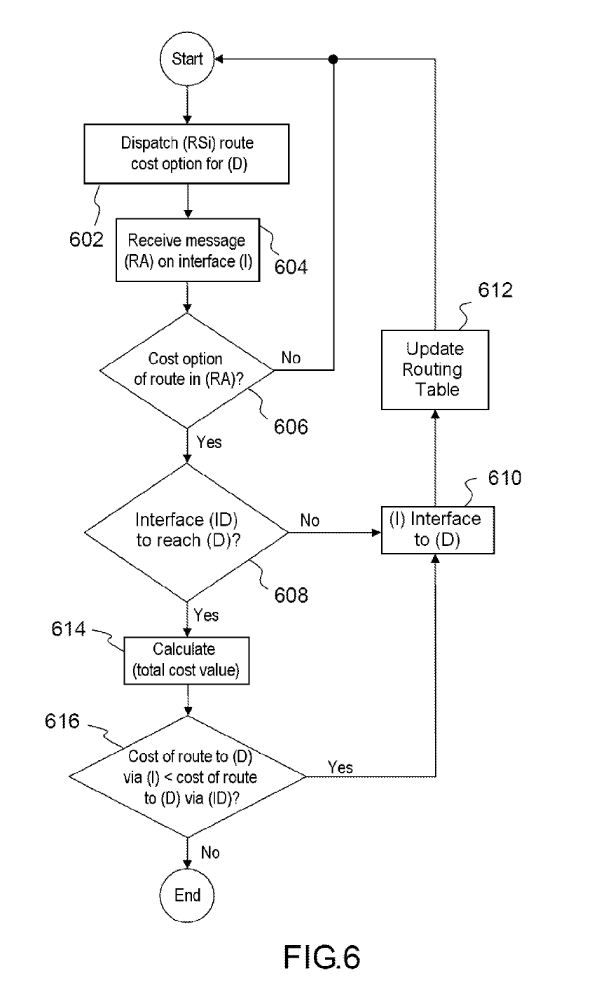

Returning to FIG. 4, when all the route cost response messages (RA11, RA21) are received by the source host (H1), the latter executes the method which is described further on with reference to FIG. 6 for selecting the interface corresponding to the route chosen for the dispatching of the data between the source host (H1) and the recipient host (H2).

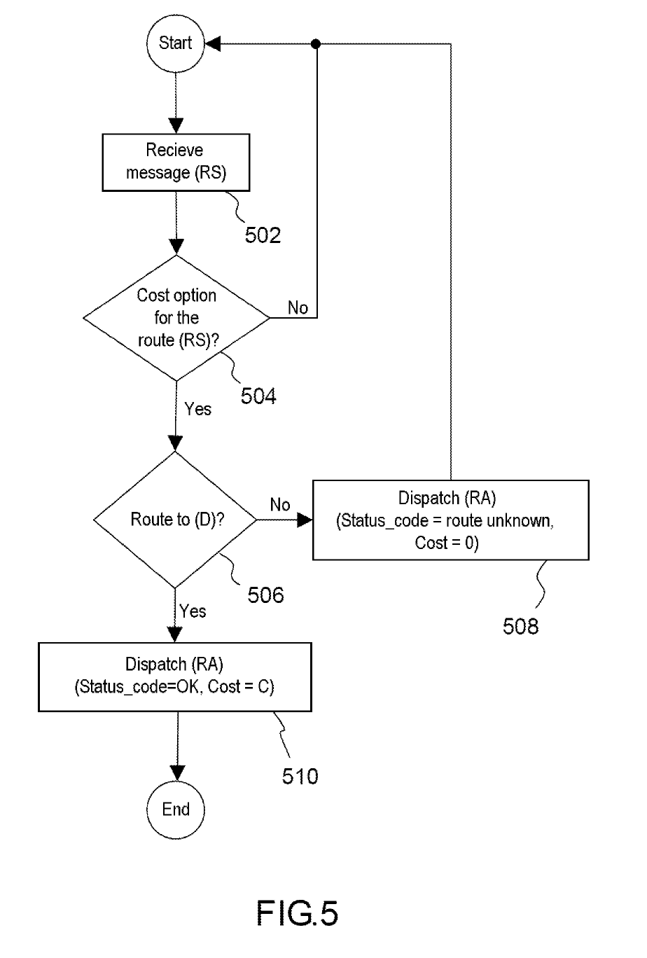

FIG. 5 shows the procedures executed by a router to advertise the cost of a route to a destination (D) requested by a source host.

On reception (502) of a Router Solicitation (RS) message dispatched by a source host, the method verifies in step (504) whether the route cost indication option is activated. If the option is not activated (NO branch) the method waits for the reception of a new solicitation message. If the route cost indication option is activated (YES branch), the method advances to the following step (506) to verify whether there exists a route recorded in the routing table of the router for the destination requested. If no recorded route exists (NO branch), a message (RA) is dispatched to the source host in step (508) indicating in the “Status Code” field that no route exists. The “Path Cost” field is set to zero.

If there exists a recorded route to the destination requested (YES branch), the method passes to the following step (510) where a response message (RA) is dispatched to the source host indicating the value of the cost of the route in the “Path Cost” field. The method then stops.

FIG. 6 shows the procedures executed by a source host to select a route for the dispatching of data to a recipient host.

The method starts when a source host must dispatch data to a recipient host (D). The source host generates (step 602) a route cost solicitation message (RSi) in respect of the destination requested from each of its interfaces.

On reception (604) of an advertisement message (RA1 or RA2 of FIG. 4) on an interface, the method verifies (step 606) whether the route cost option is activated in the message. If the option is not activated (NO branch), the method resumes at the start. If the option is activated (YES branch), the method passes to the following step (608) where it verifies whether an identifier (ID) of another interface is already recorded in the routing table of the source host for the destination requested. If no interface is selected (NO branch), the method allocates the message reception interface for the destination requested (step 610) and undertakes the updating of the routing table of the host (step 612) by storing an identifier for the allocated interface.

In step 608, if an interface (ID) is already allocated (YES branch), the method calculates (step 614) the total route cost for transmitting the data via the advertisement message reception interface while taking into account the link cost of the corresponding link of the router. Next, the method compares (step 616) the total route cost via the interface for receiving the advertisement message (RA), with the total route cost via the recorded interface (ID).

If the calculated total route cost is less than the total route cost via the already recorded interface (ID) (YES branch), the method selects the new interface (step 610) for the dispatching of data to the destination requested and updates its routing table (step 612), otherwise (NO branch), the method preserves the interface (ID) allocated and stops.

Thus in the example of FIG. 3, the sender host (102) that has to dispatch data to the recipient host (302) whilst it does not possess any specific route destined for this host in its routing table, sends a solicitation message (RS) containing the cost option of the route destined for the host (302), on each of its interfaces (103, 105). Each router responds to it through an advertisement message (RA) containing the cost of the best path at its disposal for reaching the recipient host (302). The first router (104-1) responds with a link cost of value “2” via the link 304, while the second router (104-2) responds with a link cost of total value “6” via the links (110) and (304). The source host is already aware of the cost of the first and second links (106) and (108) through the routers. It then calculates the total cost to reach the recipient host. In the example chosen, the route from the first interface (103) via the first router (104-1) amounts to a total route cost of value “7” and the route from the second interface (105) via the second router (104-2) amounts to a total route cost of value “9”. The first interface (103) is selected by the source host to send the data destined for the recipient host (302). This item of information is stored as a new entry in the routing table of the source host.

According to the routing policy set in place, either the identity of the recipient host is recorded if the policy is of “Host-based routing” type, or the link identifier in respect of the recipient host is recorded if the policy is of “Network-based routing” type.

A person skilled in the art will appreciate that variations may be effected with regard to the scheme such as described in a preferential manner and to a nonlimiting example, while preserving the principles of the invention. Thus, the examples described are based on a route selection according to an unspecified cost/metric, and it is possible to apply the same principles with regard to various metrics. Likewise, the example chosen is based on the IPv6 protocol, but the same principles remain applicable to the IPv4 protocol.

In an implementation variant with choice of multi-metric routing, the routers possess various routing tables, each of the latter being associated with a different cost/metric, such as for example bandwidth, latency, packet loss rate, security level of the link, the energy of transmission of a packet over the link, to cite just a few. In this variant, the multi-metric routing can for example be carried out by using several instances having different metrics, on one and the same routing protocol (for example OSPF, IS-IS) or on different routing protocols in one and the same network.

For this variant, in the step of advertising the cost of the link and the default interface selection (FIGS. 2a, 2b), the messages (RA) dispatched by the routers include the costs associated with several metrics or with all the routing metrics used in the network. In the case where several metrics are advertised in a message (RA), the message contains for each of them a metric identifier and a link cost associated with this metric. On the basis of the messages received, the multi-interface host node can thus configure in its local routing table a default route for each of the routing metrics.

The format of the multi-metric cost advertisement option in respect of a message (RA) is schematically illustrated hereinbelow, where the “Metric ID i” fields represent the identifier of the metric ‘i’ considered and the “Link Cost i” fields represent the cost of the link associated with the metric ‘i’.

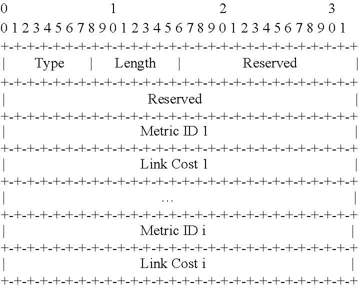

The step of discovering the cost of the routes (FIGS. 5 and 6) encompasses the possibility for the multi-interface host node to specify in the message (RS) destined for its neighbor routers the metric or metrics that it wishes to take into account for determining the cost of the end-to-end route to a given destination, by indicating the identifier(s) of the metrics in the message (RS). The neighbor routers respond by indicating in their messages (RA) the identifiers of the metrics associated with the costs of the routes to the destination according to each of the metrics requested. On the basis of the messages received, the multi-interface host node can configure in its local routing table an optimal route to a given destination for one or more specific routing metrics.

The format of the multi-metric route cost advertisement option in respect of a message is schematically illustrated hereinbelow:

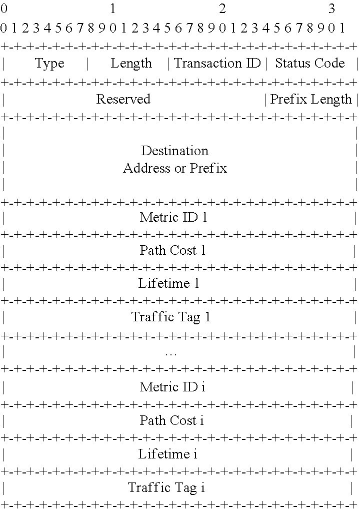

The “Metric ID i” fields represent the identifier of the metric ‘i’ considered and the “Path Cost i” fields represent the route cost associated with the metric ‘i’, the “Lifetime i” fields represent the duration of validity in seconds of the item of information advertised in the message (RA) and the “Tag Traffic i” fields represent the traffic labeling to be applied to the data packets having to be routed according to the associated metric ‘i’. This item of information allows the host node to know which labeling to apply to its data packets to benefit from a routing according to a particular metric. The IPv4 and IPv6 standards define fields dedicated to the labeling of the packets. The latter are situated in the IP header of the packets on the “Differentiated Point Code Services (DSCP)” fields for IPv4 and “Traffic Class” and “Flow Label” fields for IPv6.

The person skilled in the art will appreciate that another solution for labeling packets may also be envisaged in IPv6 solely, that of using an IP header extension.

A present invention may be implemented on the basis of hardware and/or software elements. It may be available in the guise of a computer program product on a computer readable medium. The medium may be electronic, magnetic, optical, electro-magnetic or be a diffusion medium of infrared type. Such media are, for example, semi-conductor memories (Random Access Memory RAM, Read-Only Memory ROM), tapes, magnetic or optical diskettes or disks (Compact Disk-Read Only Memory (CD-ROM), Compact Disk-Read/Write (CD-R/W) and DVD).

1. In a communication network consisting of a plurality of routers connected by communication links and comprising at least one source host equipped with several communication interfaces for sending and receiving data, each interface being connected to a router of the communication network via a communication link having a link cost, a method for selecting an interface of the source host for transmitting data to a destination host connected to the communication network, the method comprising the steps of:
sending from each interface of the source host a solicitation message to the router to which said interface is connected, to request the route cost to the destination host;
receiving on the corresponding interface of the source host an advertisement message of the router to which said interface is connected giving a value of the route cost from said router to the destination host;
calculating on the basis of the values received and of the link cost value of the corresponding link, the value of the total route cost to the destination host from the source host for each interface;
comparing the total route cost values obtained; and
selecting the interface corresponding to the lowest value of total route cost.

2. The method as claimed in claim 1, in which the step of route cost advertisement message reception comprises a step of verifying whether the advertisement message received contains a route cost option, or ignoring the message.

3. The method as claimed in claim 2, comprising an initial step of selection of a default interface for the source host.

4. The method as claimed in claim 2, comprising before the selection step, a step of determining the link cost of the link between each interface of the source host and the router to which said interface is connected.

5. The method as claimed in claim 1, moreover comprising a step of storing in a routing table of the source host an identifier of the selected interface.

6. The method as claimed in claim 4, in which the selection step consists in receiving on each interface of the source host an advertisement message of the router to which said interface is connected comprising a link cost value calculated according to a link cost calculation metric defined for said communication network.

7. The method as claimed in claim 1, in which the protocol of said communication network is the IPv6 protocol.

8. The method as claimed in claim 3, in which the step of selecting a default interface is done according to a neighbor discovery protocol.

9. The method as claimed in claim 1, in which the links of said communication network are wired and/or wireless.

10. The method as claimed in claim 1, in which the route cost advertisement message contains the address of the destination host.

11. The method as claimed in claim 1, in which the link cost is calculated for various routing metrics.

12. The method as claimed in claim 11, in which the solicitation message contains an indication of the metric or metrics for which to calculate the route cost.

13. In a communication network consisting of a plurality of routers connected by communication links and comprising at least one source host equipped with several communication interfaces for transmitting data, each interface being connected to a router of the communication network via a communication link having a link cost, a system for selecting an interface of the source host for transmitting data to a destination host connected to the communication network, the system comprising means for implementing the steps of the method as claimed in claim 1.

14. A computer program product, said computer program comprising code instructions to perform the steps of the method as claimed in claim 1, when said program is executed on a computer.
